(19) United States
(12) Patent Application Publication
(10) Pub. No.: US 2014/0367278 A1
(43) Pub. Date: Dec. 18, 2014

(54) Methods for Detecting Survival Motor Neuron (SMN) Protein in Whole Blood or Cerebral Spinal Fluid

(71) Applicant: PharmOptima, LLC, Portage, MI (US)

(72) Inventors: Phillip Zaworski, Lawton, MI (US); Roger Poorman, Portage, MI (US); Douglas Decker, Kalamazoo, MI (US)

(73) Assignee: PharmOptima, LLC, Portage, MI (US)

(21) Appl. No.: 14/301,777

(22) Filed: Jun. 11, 2014

Related U.S. Application Data
(60) Provisional application No. 61/834,325, filed on Jun. 12, 2013.

(51) Int. Cl. G01N 27/327

(52) U.S. Cl. CPC G01N 27/327
USPC 205/792

(57) ABSTRACT

A method for determining the level of survival motor neuron (SMN) protein in a whole blood or cerebral spinal fluid (CSF) sample, for example, a whole blood lysate sample or a CSF sample, including obtaining a whole blood or cerebral spinal fluid (CSF) sample from the subject and conducting an electrochemiluminescence immunoassay to determine the level of SMN in the whole blood or cerebral spinal fluid (CSF) sample.

### CROSS-REFERENCE TO RELATED APPLICATIONS

This application claims the benefit of U.S. Provisional Application Ser. No. 61/834,325, filed Jun. 12, 2013. The disclosure of this Provisional Application is incorporated by reference herein in its entirety.

### INCORPORATION BY REFERENCE OF MATERIAL SUBMITTED ELECTRONICALLY

Incorporated by reference in its entirety is a computer-readable sequence listing submitted concurrently herewith and identified as follows: One 6 KB ASCII (Text) file named “223283-356761_Sequence_Listing_ST25.txt,” created on Jun. 5, 2014, at 4:13 pm.

### BACKGROUND OF THE INVENTION

Spinal Muscular Atrophy (SMA) is an autosomal recessive genetic motor neuron disease and generally refers to a group of diseases of the motor nerves that cause muscle weakness and atrophy (wasting). SMA affects muscles throughout the body.

SMA is caused by a missing or abnormal (mutated) gene known as the “survival motor neuron 1” gene (SMN1). The SMN1 gene produces the survival motor neuron (SMN1) protein. With missing or mutated SMN1 genes, the SMN protein either is absent or its levels are significantly decreased causing severe problems for alpha motor neurons (nerve cells in the spinal cord which send out nerve fibers to muscles throughout the body). Since the SMN1 protein is critical to motor neurons, nerve cells may shrink and eventually die without this protein, resulting in muscle weakness. The range of severity of SMA is partially attributed to the variable copy number of a neighboring related gene known as the “survival motor neuron 2” gene (SMN2) which produces SMN2 protein even in individuals with SMA. See also, U.S. Pat. No. 6,080,577, describing these two forms of SMN, which is incorporated herein by reference.

SMA occurs across a wide range of severity. Individuals with SMA are grouped into four types (I, II, III, IV) based on their level of motor function and the physical milestones achieved by the individual.

Diagnosis of children with SMA Type I are usually made before 6 months of age. Usually children with SMA Type I have poor head control and are not able to accomplish developmentally-expected motor skills. Children with this type of SMA eventually will lose the ability to swallow safely without aspirating. The diagnosis of SMA Type II is almost always made before 2 years of age. Children with this type have delayed motor milestones and display a range of physical abilities. Children with SMA Type II usually do not have swallowing problems. SMA Type III, also known as Kugelberg-Welander Disease, or Juvenile Spinal Muscular Atrophy, is typically diagnosed by 3 years of age, but can be diagnosed as late as the teenage years. The hallmark feature of SMA Type III is the ability to stand and walk independently, but affected individuals may have difficulty walking, running, and climbing stairs as they get older. SMA Type IV is the adult onset form of SMA. Symptoms usually begin in the second or third decade of life, typically after the age of 35. SMA Type IV is characterized by mild motor impairment such as muscle weakness, tremor, and twitching, with or without respiratory problems, and is less common than the other SMA types.

About 1 out of 40 people are genetic “carriers” of the disease, that is, they have a mutated or missing SMN1 gene, but not SMA. To be affected by SMA, both parents usually are carriers of the abnormal SMN1 gene and pass this gene on to their child. Thus, a child with SMA has two abnormal copies of the SMN1 gene, one from each parent, i.e., SMA is an autosomal recessive genetic disease.

SMA is diagnosed primarily with a blood test which detects the presence or absence of the SMN1 gene, a suggestive history, and a physical examination.

As SMA drug development progresses both pre-clinical and clinical studies require accessible and less invasive sources of testing samples in order to monitor the effect of treatments on SMN production. Recent interest has been directed at the detection of SMN in both plasma and cerebral spinal fluid (CSF). To date, however, attempts at measuring SMN in these biological samples have not been successful.

### BRIEF SUMMARY OF THE INVENTION

The inventive method includes an electrochemiluminescence (ECL) based immunoassay for determining the level of survival motor neuron (SMN) in a whole blood or CSF sample, for example, sampled whole blood or component thereof and cerebral spinal fluid.

In one aspect, the invention provides a method for determining the level of survival motor neuron (SMN) protein in a whole blood or CSF sample obtained from a subject, the method including the steps: obtaining a whole blood or CSF sample from the subject, and conducting an electrochemiluminescence immunoassay to detect a level of SMN in the whole blood or CSF sample.

In a related embodiment, the invention provides a method for determining the level of survival motor neuron (SMN) protein in whole blood or a cellular component thereof obtained from a subject, the method including the steps: obtaining a whole blood sample from the subject; creating a whole blood lysate (WBL) from the whole blood sample obtained from the subject, and conducting an electrochemiluminescence immunoassay using the WBL to detect a level of SMN in the WBL.

In another embodiment, the invention provides a method for determining the level of survival motor neuron (SMN) protein in a cerebrospinal fluid sample from a subject, the method including the steps: obtaining a cerebrospinal fluid sample from the subject; and conducting an electrochemiluminescence immunoassay using the sampled cerebrospinal fluid to detect a level of SMN in the cerebrospinal fluid. In various embodiments, the subject may be a subject diagnosed with SMA, or a subject suspected of having SMA, for example, subjects exhibiting one or more symptoms of SMA or having at least one parent who is an SMA carrier as defined herein.

Further, the invention includes provides a method for determining the level of survival motor neuron (SMN) protein in cerebral spinal fluid (CSF) from a subject, including: obtaining a CSF sample from the subject; and conducting an electrochemiluminescence immunoassay to detect a level of SMN in the CSF sample. The subject may be a patient diagnosed with Spinal Muscular Atrophy or is at risk for developing Spinal Muscular Atrophy (for example, has at least one parent who is a carrier of the faulty SNM1 gene). In one embodiment, the immunoassay may detect survival motor neuron 2 (SMN2) protein or a truncated version of SMN2 lacking exon 7, using an anti-SMN2 capture antibody and an anti-SMN2 detection antibody that each specifically bind to SMN2 and/or SMN2 lacking exon 7. In some embodiments, an exemplary anti-SMN2 capture antibody may be a 2B1 mouse monoclonal antibody and an exemplary anti-SMN2 detection antibody may be a rabbit anti-SMN2 polyclonal antibody. Further, the anti-SMN2 detection antibody may be tagged with an ECL label, for example, an amine-reactive, N-hydroxysuccinimide ester linked to a caged ruthenium.

In another aspect, the inventive methods include provision of an electrochemiluminescence reader: for electrochemically stimulating the tag; and using the reader to detect the level of SMN protein in the biological sample, preferably, a whole blood lysate or cerebrospinal fluid.

### BRIEF DESCRIPTION OF THE DRAWING(S)

FIG. 1 shows the structure of a caged ruthenium tag which emits light in response to an electric current.

FIG. 2 shows a sandwich immunoassay format for electrochemiluminescence (ECL) technology using a MesoScale Discovery (a division of Meso Scale Diagnostics, LLC; “MSD”) platform and how the signal is generated.

FIG. 3 is a line graph comparison of replicate SMN Standard curves.

FIG. 4 is a table depicting levels of SMN detected in plasma and contaminated plasma samples with whole blood lysate using the ECL immunoassay in accordance with the present disclosure.

FIG. 5 is a table depicting levels of SMN detected in cerebral spinal fluid contaminated with whole blood lysate using an ECL immunoassay in accordance with the present disclosure.

FIG. 6 depicts a line graph demonstrating the parallelism between a SMN standard curve and a mouse whole blood dilution curve using an ECL immunoassay in accordance with the present disclosure.

FIG. 7 depicts a line graph demonstrating the fidelity of detection using ECL based immunoassays to detect and measure SMN from mouse whole blood and mouse whole blood lysate.

FIG. 8 demonstrates parallelism between an SMN standard curve and a human whole blood dilution curve. More specifically, FIG. 8 shows parallelism and good spike recovery in human whole blood (the same points as described in FIG. 6 with mouse blood). Note that human whole blood contains less SMN than mouse blood; this may be due to different amounts of a given cell type in mouse versus human blood.

FIG. 9 shows a line graph depicting the correlation between ECL-SMN with SMN-ELISA in human PBMC lysates.

FIG. 10 shows a scatter plot illustrating the statistically significant differences in SMN levels in mice with different genotypes using the SMN ECL immunoassay methodology in accordance with the present disclosure.

FIG. 11 shows a scatter plot illustrating the statistically significant differences in SMN levels in human carriers and patients.

FIG. 12 shows a line graph comparing the sensitivity and dynamic range of an ELISA based assay to detect SMN in a standard sample and SMN in WBL.

These figures are provided by way of example and are not intended to limit the scope of the invention.

### DETAILED DESCRIPTION OF THE PREFERRED EMBODIMENTS

Before the subject invention is described further, it is to be understood that the invention is not limited to the particular embodiments of the invention described below, as variations of the particular embodiments may be made and still fall within the scope of the appended claims. It is also to be understood that the terminology employed is for the purpose of describing particular embodiments, and is not intended to be limiting. Instead, the scope of the present disclosure will be established by the appended claims.

Where a range of values is provided, it is understood that each intervening value, to the tenth of the unit of the lower limit unless the context clearly dictates otherwise, between the upper and lower limit of that range, and any other stated or intervening value in that stated range, is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either or both of those included limits are also included in the invention.

All references, patents, patent publications, articles, and databases, referred to in this application are incorporated herein by reference in their entirety, as if each were specifically and individually incorporated herein by reference. Such patents, patent publications, articles, and databases are incorporated for the purpose of describing and disclosing the subject components of the invention that are described in those patents, patent publications, articles, and databases, which components might be used in connection with the presently described invention. The information provided below is not admitted to be prior art to the present disclosure, but is provided solely to assist the understanding of the reader.

For clarity of disclosure, and not by way of limitation, the detailed description of the invention is divided into the subsections that follow.

Unless defined otherwise, all technical and scientific terms used herein have the meaning commonly understood by one of ordinary skill in the art to which this invention belongs. See, e.g. Singleton et al., Dictionary of Microbiology and Molecular Biology 2nd ed., J. Wiley & Sons (New York, N.Y. 1994); Sambrook et al., Molecular Cloning, A Laboratory Manual, Cold Spring Harbor Press (Cold Spring Harbor, N.Y. 1989). These references are hereby incorporated into this disclosure by reference in their entireties. Generally, the nomenclature used herein and the laboratory procedures in cell culture, molecular genetics, organic chemistry and nucleic acid chemistry described below are those well-known and commonly employed in the art. Although any methods, devices and materials similar or equivalent to those described herein can be used in the practice or testing of the invention, the preferred methods, devices and materials are now described.

In this specification and the appended claims, the singular forms “a,” “an” and “the” include plural reference unless the context clearly dictates otherwise.

As used herein, the term “about” means plus or minus 10% of the numerical value of the number with which it is being used. Therefore, about 50% means in the range of 45%-55%.

The term “subject” or “patient” generally refer to any living organism from which a sample described herein is taken and may include, but is not limited to, any mammalian species, including, human, primate, or non-human mammal. Examples include, but are not limited to, a human patient diagnosed with SMA, or at risk of developing SMA, an experimental animal or model, such as a mouse, rat, rabbit, guinea pig, hamster, ferret, dog, cat, and the like. In some embodiments, a subject may also include non-mammalian animals, or non-vertebrate animals. Also, a “subject” may or may not be exhibiting the signs, symptoms, or pathology of SMA of any type.

As used herein, “protein” is a polymer consisting essentially of any of the 20 amino acids. Although “polypeptide” is often used in reference to relatively large polypeptides, and “peptide” is often used in reference to small polypeptides, usage of these terms in the art overlaps and is varied. The terms “peptide(s)”, “protein(s)” and “polypeptide(s)” are used interchangeably herein.

The terms “red blood cell”, “RBC” or “erythrocyte” can be interchangeably used.

As used herein, the term “whole blood” is used in its broadest sense. In one sense, it is used to mean blood drawn directly from the body of a subject (for example, unseparated venous blood) from which none of the components has been removed. Components of whole blood include, but are not limited to, red blood cells, reticulocytes, platelets, peripheral blood mononuclear cells (PBMCs), polymorphonuclear cells (PMNs), granulocytes, and plasma.

The term “SMN protein” refers to mammalian and/or non-mammalian SMN protein from any mammalian and/or non-mammalian species, for example, human. Illustrative SMN protein can include full length mature SMN1, full length mature SMN2 and truncated SMN2 lacking exon 7, illustratively shown as human full length mature SMN1 and full length mature SMN2 as indicated in SEQ ID NOs 1& 2 respectively.

As used herein, the term “antibody” refers to polyclonal antibodies, monoclonal antibodies, humanized antibodies, single-chain antibodies, and fragments thereof such as F_{ab}, F_{(ab′)2}, Fᵥ, and other fragments that retain the antigen binding function of the parent antibody. As such, an antibody may refer to an immunoglobulin or glycoprotein, or fragment or portion thereof, or to a construct comprising an antigen-binding portion comprised within a modified immunoglobulin like framework, or to an antigen-binding portion comprised within a construct comprising a non-immunoglobulin-like framework or scaffold.

As used herein, the term “monoclonal antibody” refers to an antibody composition having a homogeneous antibody population. The term is not limited regarding the species or source of the antibody, nor is it intended to be limited by the manner in which it is made. The term encompasses whole immunoglobulins as well as fragments such as F_{ab}, F_{(ab′)2}, Fᵥ, and others that retain the antigen binding function of the antibody. Monoclonal antibodies of any mammalian species can be used in this invention. In practice, however, the antibodies will typically be of rat or murine origin because of the availability of rat or murine cell lines for use in making the required hybrid cell lines or hybridomas to produce monoclonal antibodies.

As used herein, the term “polyclonal antibody” refers to an antibody composition having a heterogeneous antibody population. Polyclonal antibodies are often derived from the pooled serum from immunized animals or from selected humans.

A “naturally occurring antibody” is a glycoprotein comprising at least two heavy (H) chains and two light (L) chains inter-connected by disulfide bonds. Each heavy chain is comprised of a heavy chain variable region (abbreviated herein as V_{H}) and a heavy chain constant region. The heavy chain constant region is comprised of three domains, CH1, CH2 and CH3. Each light chain is comprised of a light chain variable region (abbreviated herein as V_{L}) and a light chain constant region. The light chain constant region is comprised of one domain, C_{L}. The V_{H} and V_{L} regions can be further subdivided into regions of hypervariability, termed complementarity determining regions (CDR), interspersed with regions that are more conserved, termed framework regions (FR). Each V_{H} and V_{L} is composed of three CDRs and four framework regions (FRs) arranged from amino-terminus to carboxy-terminus in the following order: FR1, CDR1, FR2, CDR2, FR3, CDR3, FR4. The variable regions of the heavy and light chains contain a binding domain that interacts with an antigen. The constant regions of the antibodies may mediate the binding of the immunoglobulin to host tissues or factors, including various cells of the immune system (e.g., effector cells) and the first component (Clq) of the classical complement system.

The term “antigen-binding portion” of an antibody (or simply “antigen portion”), as used herein, refers to the protein sequence that binds the target, e.g., one or more CDRs which bind to SMN protein. It includes, e.g., full length antibodies, one or more fragments of an antibody, and/or CDRs on a non-immunoglobulin-related scaffold that retain the ability to specifically bind to an antigen (e.g., SMN1 or SMN2, or truncated SMN2). The antigen-binding function of an antibody can be performed by fragments of a full-length antibody. Examples of binding fragments encompassed within the term “antigen-binding portion” of an antibody include a Fab fragment, a monovalent fragment consisting of the V_{L}, V_{H}, CL and CH1 domains; a F(ab)₂ fragment, a bivalent fragment comprising two Fab fragments linked by a disulfide bridge at the hinge region; a Fd fragment consisting of the V_{H} and CH1 domains; a Fv fragment consisting of the V_{L} and V_{H} domains of a single arm of an antibody; a dAb fragment (Ward et. al., 1989 Nature 341:544-546), which consists of a V_{H} domain; and an isolated complementarity determining region (CDR).

As used herein, an “antigen” or an “epitope” interchangeably refer to a polypeptide sequence on a target protein specifically recognized by an antigen-binding portion of an antibody, antibody fragment, or their equivalents. An antigen or epitope comprises at least 6 amino acids, which may be contiguous within a target sequence, or non-contiguous. A conformational epitope may comprise non-contiguous residues, and optionally may contain naturally or synthetically modified amino acid residues. Modifications to residues include, but are not limited to: phosphorylation, glycosylation, PEGylation, ubiquitinization, furanylization, and the like.

Furthermore, although the two domains of the Fv fragment, V_{L} and V_{H}, are coded for by separate genes, they can be joined, using recombinant methods, by a synthetic linker that enables them to be made as a single protein chain in which the V_{L} and V_{H} regions pair to form monovalent molecules (known as single chain Fv (scFv); see e.g., Bird et al., 1988 Science 242:423-426; and Huston et al., 1988 Proc. Natl. Acad. Sci. 85: 5879-5883). Such single chain antibodies are also intended to be encompassed within the term “antigen-binding portion” of an antibody. These antibody fragments are obtained using conventional techniques known to those of skill in the art, and the fragments are screened for utility in the same manner as are intact antibodies.

The terms “label” or “detectable label” is any chemical group or moiety that can be linked to the target antibodies. In one embodiment of the invention, the label is a detectable ECL-label that is suitable for the sensitive detection of the target detection antibody.

“Electrochemiluminescence” or “ECL” is the process whereby a species, e.g., antibody of interest, luminesces upon the exposure of that species to electrochemical energy in an appropriate surrounding chemical environment.

As used herein, the term “ECL moiety”, “metal-containing ECL moiety” “ECL-label”, “label compound”, and “label substance”, are used interchangeably. It is within the scope of the present disclosure for the species termed “ECL moiety”, “metal-containing ECL moiety”, “organometallic”, “metal chelate”, “transition metal chelate” “rare earth metal chelate”, “label compound”, “label substance” and “label” to be linked to other molecules such as an antibody or an antibody fragment thereof. The above-mentioned species can also be linked to a combination of one or more binding partners and/or one or more reactive components. Additionally, the aforementioned species can also be linked to an antibody or an antibody fragment thereof bound to a binding partner, a reactive component, or a combination of one or more binding partners and/or one or more reactive components. It is also within the scope of the present disclosure for a plurality of the aforementioned species to be bound directly, or through other molecules as discussed above, to an antibody or antibody fragment thereof.

The term “wild-type” or “native” (used interchangeably) refers to the naturally-occurring polynucleotide sequence encoding a protein, or a portion thereof, or protein sequence, or portion thereof, respectively, as it normally exists in vivo.

The term “mutant” refers to any change in the genetic material of an organism, in particular a change (i.e., deletion, substitution, addition, or alteration) in a wild-type polynucleotide sequence or any change in a wild-type protein sequence.

As used herein, the phrase “patient diagnosed with SMA” refers to a subject who has been tested and found to have SMA of any type. The SMA may be diagnosed using any suitable method including, but not limited to, a blood test which detects the presence or absence of the SMN1 gene, a suggestive history, or a physical examination.

In some embodiments, the present disclosure provides a method for determining the level of survival motor neuron (SMN) protein in a whole blood or CSF sample using an immunoassay based analysis and measuring and quantifying and determining the amount of SMN protein in the whole blood or CSF sample. In some embodiments, the present disclosure provides a method for determining the level of survival motor neuron (SMN) protein in a whole blood sample from a subject, comprising: obtaining a whole blood sample from the subject; and conducting an electrochemiluminescence (ECL) immunoassay to determine the level of SMN in the whole blood sample.

In some embodiments, the amount of SMN protein in the whole blood or CSF sample can then be correlated to known levels of SMN protein associated with SMA and a clinical diagnosis or clinical result can be made, for example, the assay of the present disclosure can measure the amount of SMN in a patient sample to determine the effectiveness of a drug or medicament used in a clinical SMA trial. In various embodiments, the present disclosure provides immunoassays that utilize inter alia, a capture antibody and a detection antibody, wherein each of the capture antibody and the detection antibody specifically bind to SMN protein (e.g. SMN2), forming a bound complex, and wherein the bound complex is detected using electrochemiluminescence (ECL). ECL detection techniques provide a sensitive and controllable measurement of the presence and amount of SMN in a whole blood or CSF sample of interest.

### SMN ECL Immunoassay

Sample Preparation and Collection

In various embodiments of the present disclosure, whole blood or CSF samples from one or more subjects can be conveniently collected, manually or in an automated fashion, for example, a blood draw, using known phlebotomy or blood collection techniques, for example, a venipuncture procedure, a fingerstick procedure, a heelstick procedure, blood lead micro-sampling tubes, or some other means of collecting at least 0.001 mL to about 10 mL, preferably at least about 0.001 mL to about 0.5 mL of whole blood. Once the whole blood samples are collected, the samples can be treated to ensure that at least about 1% to about 100% of the cells present in the whole blood sample, preferably from about 10% to about 90%, or more preferably from about 20% to about 80% of the cells in the collected whole blood sample are lysed. In the context of whole blood, whole blood is lysed for example, about 1% to about 100% of the cells present in the biological sample, preferably from about 5% to about 90%, or more preferably from about 10% to about 80% of the cells in the collected whole blood sample are lysed to form a whole blood lysate (WBL). The degree of cell lysis in the whole blood sample can be readily determined using for example, a differential count of a peripheral blood smear on a glass slide using a wedge slide (“push slide”) technique or with a hemocytometer. The WBL can then be used in the ECL immunoassay described further below to determine the amount of SMN protein in the WBL biological sample.

In one embodiment, a WBL is prepared from a sample of whole blood obtained from a subject. In this embodiment, the whole blood is collected using an approved blood collection technique. In some embodiments, whole blood may be collected into collection tubes lacking an anticoagulant, or tubes containing an anticoagulant, for example, an anticoagulant selected from heparin, EDTA, sodium citrate and the like, and thoroughly mixed by inverting the tube 5-10 times to ensure proper mixing. The use of anticoagulant containing blood collection tubes can be useful, for example, when the subject's blood is not frozen within 5-15 minutes from collection. Non-coagulated blood collected from the subject can then be transferred into an appropriate sterile container or tube, appropriately labelled and placed into a freezer (for example, at −10° C., −18° C., −20° C., −80° C. and temperatures therebetween, etc), and stored prior to performing the SMN ECL immunoassay of the present disclosure. Once the frozen blood sample is to be interrogated to determine the amount of SMN present in the sample, the frozen blood sample is thawed (e.g. by placing the frozen blood sample in a 37° C. water bath for 3-10 minutes, or until the entire contents is thawed, and stirred vigorously, thereby generating a WBL. In some embodiments, the WBL is frozen and thawed multiple times, e.g., 2-10 times to ensure that about 1% to about 100%, or about 5% to about 90%, or more preferably from about 10% to about 80% of the cells in the whole blood sample are lysed. In various embodiments, the subject's WBL can be diluted into one of several suitable diluents, (i.e. diluting the WBL in ratios ranging from 1:2-1:200) for example, physiological saline, or other physiological buffers known in the art. In some embodiments, the diluent may be supplemented with additives such as chaotropic agents such as guanidium hydrochloride, and detergents or surfactants, at concentrations ranging from about 0.01% to about 5% (v/v). In some embodiments, useful ionic detergents include sodium dodecyl sulfate (SDS, sodium lauryl sulfate (SLS)), sodium laureth sulfate (SLS, sodium lauryl ether sulfate (SLES)), ammonium lauryl sulfate (ALS), cetrimonium bromide, cetrimonium chloride, cetrimonium stearate, and the like. Useful non-ionic (zwitterionic) detergents include polyoxyethylene glycols, polysorbate 20 (also known as Tween 20), other polysorbates (e.g., 40, 60, 65, 80, etc), Triton-X (e.g., X100, X114), 3-[(3-cholamidopropyl)dimethylammonio]-1-propanesulfonate (CHAPS), CHAPSO, deoxycholic acid, sodium deoxycholate, NP-40, glycosides, octyl-thio-glucosides, maltosides, and the like. In some embodiments, Pluronic F-68, a surfactant shown to reduce platelet aggregation, and can be used from a 0.1% to 5% concentration, e.g., a 1%, 2.5% or 5% concentration (v/v). The pH and/or ionic strength of the solution can be adjusted with various acids, bases, buffers or salts, including without limitation sodium chloride (NaCl), phosphate-buffered saline (PBS), tris-buffered saline (TBS), sodium phosphate, potassium chloride, potassium phosphate, sodium citrate and saline-sodium citrate (SSC) buffer. The diluted WBL can be used to generate one or more samples for testing in the SMN ECL immunoassay of the present disclosure. In various embodiments, a suitable diluent, is generally a diluent that does not interfere in the SMN ECL immunoassay's ability to detect SMN in a biological sample.

In various embodiments, the whole blood sample can include a cellular fraction obtained from the subject's collected whole blood, for example, a red blood cell fraction, or a platelet cell fraction, or a peripheral blood mononuclear cell (PMBC) fraction or a polymorphonuclear cell (PMN) fraction, or combinations thereof. Methods for isolating these various cellular fractions or cell types are known in the art, e.g. Ficoll or Lymphoprep density gradient separation and Cell Preparation Tubes (CPT) using established hematological procedures known in the art.

In various embodiments, the subject's collected sample can be cerebral spinal fluid (CSF). Methods for collecting CSF can include: lumbar puncture, commonly called a spinal tap, cisternal puncture, and ventricular puncture. In some embodiments, the biological sample is lumbar punctured CSF, which may or may not be frozen and thawed prior to use in the present disclosure's SMN ECL immunoassay.

ECL Immunoassays

In various embodiments of the methods of the present disclosure, detection of SMN protein in whole blood or CSF samples is performed using electrochemiluminescence based immune assays (immunoassays) involving a ECL-labeled antibody. Electrochemiluminescence (“ECL”) is the phenomena whereby an electrically excited species emits a photon (see, e.g., Leland and Powell, 1990 J. Electrochem. Soc. 137(10):3127-3131). Species from which ECL can be induced are termed ECL labels. Commonly used ECL labels include: organometallic compounds where the metal is for example, a noble metal of group VIII, including Ru-containing and Os-containing organometallic compounds such as the Ru(2,2′-bipyridine)₃²⁺ moiety (also referred to as “Rubpy”), as disclosed, e.g., by Bard et al. (U.S. Pat. No. 5,238,808). “Rubpy” also include derivatives of Ru(2,2′-bipyridine)₃²⁺. Fundamental to ECL-based detection systems is the need for an electrical potential to excite the ECL label to emit a photon. An electrical potential waveform is applied across an electrode surface, typically a metal surface, and a counterelectrode (see e.g., U.S. Pat. Nos. 5,068,088, 5,093,268, 5,061,445, 5,238,808, 5,147,806, 5,247,243, 5,296,191, 5,310,687, 5,221,605). The ECL is promoted to an excited state as a result of a series of chemical reactions triggered by the electrical energy received from the working electrode. A molecule which promotes ECL of the ECL label is advantageously provided, such as oxalate or, more preferably, tripropylamine (see U.S. Pat. No. 5,310,687).

Various assay formats can be employed in the practice of the methods of the present disclosure, as will be apparent to those skilled in the art. These include a sandwich immunoassay using, for example, magnetic beads or other solid support, such as carbon fibrils and a pair of antibodies specific for SMN protein, wherein the first anti-SMN antibody binds to SMN, and a second anti-SMN antibody that binds to SMN at an epitope distinct from the first antibody and which second antibody contains an ECL label (see, e.g., The Immunoassay Handbook, D. Wild, Ed. (1994) Stockton Press, New York).

The excitation of an ECL label in an ECL reaction typically involves diffusion of the ECL label molecule to the surface of an electrode. Other mechanisms for the excitation of an ECL label molecule by an electrode include the use of electrochemical mediators in solution (Haapakka, 1982, Anal Chim. Acta, 141:263) and the capture of beads on an electrode, the beads presenting complexes of bound analyte and secondary antibodies conjugated with ECL label molecules (PCT published applications WO 90/05301 and WO 92/14139). The light generated by ECL labels can be used as a reporter signal in diagnostic procedures (Bard et al., U.S. Pat. No. 5,221,605). In some embodiments, an ECL label can be covalently coupled to a detection antibody. The capture antibody-SMN protein-detection antibody complex can be used to determine the levels of SMN protein in WBL or CSF samples and overcomes ELISA based color detection methods due to the inherent problem of WBL as a sample. (Bard et al., U.S. Pat. No. 5,238,808).

Various apparatus well known to the art are available for conducting, reading and quantifying electrochemiluminesence in ECL reactions. For example, Zhang et al. (U.S. Pat. No. 5,324,457) discloses exemplary electrodes for use in electrochemical cells for conducting ECL. Leventis et al. (U.S. Pat. No. 5,093,268) discloses electrochemical cells for use in conducting ECL reactions. Kamin et al. (U.S. Pat. No. 5,147,806) discloses apparatus for conducting, reading, and quantifying ECL reactions, including voltage control devices. Zoski et al. (U.S. Pat. No. 5,061,445) discloses apparatus for conducting, reading and detecting ECL reactions, including electrical potential waveform diagrams for eliciting ECL reactions, digital to analog converters, control apparatus, detection apparatus and methods for detecting current generated by an ECL reaction at the working electrode to provide feedback information to the electronic control apparatus. Commercial systems, including ECL readers for performing ECL immunoassays are also well known, for example, Elecsys® immunoassays using Cobas® analyzers, (Roche Diagnostics International, Rokkreuz, CH), ORIGEN Analyzer (IGEN Inc., USA), and Meso Scale Discovery MULTI-ARRAY immunoassays and SECTOR imagers (MSD® platform, MSD Rockville, Md., USA).

Having described the ECL process generally, in one embodiment of the methods of the present disclosure, the SMN ECL immunoassay determines and measures the amount of SMN in a WBL or CSF sample with the use of a pair of anti-SMN antibodies (a capture antibody and a detection antibody labeled with an ECL label) in a sandwich format, optionally when referenced to a standard curve of SMN protein at one or more dilutions in a buffer using the ECL immunoassays of the present disclosure. In various embodiments, the SMN ECL immunoassay of the present invention is performed using WBL which is formed after obtaining a whole blood sample from the subject. The quantified amount of SMN in the WBL can then easily be normalized to an amount of SMN from the subject's collected whole blood.

In various embodiments, the capture antibody is an antibody or fragment thereof, which possesses an antigen binding site that specifically adheres to a SMN protein, for example, a protein having the amino acid sequence of SEQ ID NO: 1 or 2 or SMN2 proteins that lack an Exon 7 coding C-terminal portion. In some embodiments, the capture antibody is Sigma monoclonal antibody anti-SMN clone 2B1 (Catalog No. #S2944, Sigma Aldrich, St. Louis Mo., USA) and can be coated onto a planar electrode surface or magnetic beads to capture SMN protein or reagents. In some embodiments, the beads are then moved adjacent to a working electrode for enhanced sensitivity.

Electrochemiluminescent (ECL) assay techniques are an improvement on chemiluminescent techniques. They provide a sensitive and precise measurement of the presence and concentration of an analyte of interest. In such techniques, the incubated sample is exposed to a voltammetric working electrode in order to trigger luminescence. In the proper chemical environment, such electrochemiluminescence is triggered by a voltage impressed on the working electrode at a particular time and in a particular manner. The light produced by the ECL label present on an SMN detection antibody is measured and indicates the presence and quantity of SMN protein. For a description of such ECL techniques, see, e.g., U.S. Pat. No. 5,238,808, WO86/0273, U.S. Pat. No. 6,887,714, U.S. Pat. No. 8,541,174, Blackburn et al. (1991), “Electrochemiluminescence detection for development of immunoassays and DNA probe assays for clinical diagnostics,” Clin. Chem. 37(9)1534-1539, each of which is incorporated by reference herein in its entirety.

Typically, the SMN protein of interest is present in SMA patients at a concentration ranging between about 0.1-50,000 pg/mL of whole blood or CSF samples or less, for example, at least as low as 0.1-5,000 pg/mL of whole blood or CSF samples. In several embodiments, a feature of the invention is the utilization of metal-containing ECL labels which are capable of electrochemiluminescence (ECL). In one embodiment, the ECL label is a metal chelate. The metal of that chelate is suitably any metal such that the metal chelate will luminesce under the electrochemical conditions that are imposed on the reaction system in question. The metal of such metal chelates is, for instance, a transition metal (such as a d-block transition metal) or a rare earth metal. The metal can be ruthenium, osmium, rhenium, iridium, rhodium, platinum, indium, palladium, molybdenum, technetium, copper, chromium or tungsten. The function of the ECL labels in the present disclosure is to emit electromagnetic radiation as a result of introduction into the reaction system of electrochemical energy. In order to do this, they must be capable of being stimulated to an excited energy state and also capable of emitting electromagnetic radiation, such as a photon of light, upon descending from that excited state. While not wishing to be bound by theoretical analysis of the mechanism of the ECL label's participation in the electrochemiluminescent reaction, it is believed that it is oxidized by the introduction of electrochemical energy into the reaction system and then, through interaction with a reductant present in the system, is converted to the excited state. This state is relatively unstable, and the metal chelate quickly descends to a more stable state. In so doing, the chelate gives off electromagnetic radiation, such as a photon of light, which is detectable.

The ligands which are linked to the metal in such chelates are usually heterocyclic or organic in nature, and play a role in determining whether or not the metal chelate is soluble in an aqueous environment or in an organic or other nonaqueous environment. The ligands can be polydentate, and can be substituted. Polydentate ligands include aromatic and aliphatic ligands. Suitable aromatic polydentate ligands include aromatic heterocyclic ligands. Preferred aromatic heterocyclic ligands are nitrogen-containing, such as, for example, bipyridyl, bipyrazyl, terpyridyl, and phenanthrolyl. Suitable substituents include for example, alkyl, substituted alkyl, aryl, substituted aryl, aralkyl, substituted aralkyl, carboxylate, carboxaldehyde, carboxamide, cyano, amino, hydroxy, imino, hydroxycarbonyl, aminocarbonyl, amidine, guanidinium, ureide, sulfur-containing groups, phosphorus containing groups, and the carboxylate ester of N-hydroxysuccinimide. The chelate may have one or more monodentate ligands, a wide variety of which are known to the art. Suitable monodentate ligands include, for example, carbon monoxide, cyanides, isocyanides, halides, and aliphatic, aromatic and heterocyclic phosphines, amines, stilbenes, and arsines.

Examples of suitable chelates are bis [(4,4′-carbomethoxy)-2,2′-bipyridinel]2-[3-(4-methyl-2,2′-bipyridine-4-yl-)propyl]-1,3-dioxolane ruthenium (II); bis(2,2′ bipyridine) [4-(butan-1-a1)-4′-methyl-2,2′-bipyridine]ruthenium (II); bis(2,2′-bipyridine). [4-(4′-methyl-2,2′-bipyridine-4′-yl)-butyric acid]ruthenium (II); (2,2′-bipyridine) [bis-bis(1,2-diphenylphosphino)ethylene]2-[3-(4-methyl-2,2′-bipyridine-4′-yl)propyl]-1,3-dioxolane osmium (II); bis(2,2′-bipyridine) [4-(4′-methyl-2,2′-bipyridine)-butylamine]ruthenium (II); bis(2,2′-bipyridine) [1-bromo-4(4′-methyl-2,2′-bipyridine-4-yl)butane]ruthenium (II); bis(2,2′-bipyridine)maleimidohexanoic acid, 4-methyl-2,2′-bipyridine-4′-butylamide ruthenium (II).

In some embodiments of the present disclosure, the ECL labels (e.g. SULFO-TAG; Meso Scale Discovery MULTI-ARRAY immunoassays; MSD® platform, MSD Rockville, Md., USA) are conjugated to antibodies that bind to SMN protein and are specific to binding SMN at epitopes other than epitopes encoded by exon 7 of SMN2. These antibodies are referred to herein as detection antibodies. Generally speaking, in some embodiments, the capture-detection antibodies can be used in a sandwich immunoassay, wherein the capture antibody binds the SMN protein and the detection antibody also binds to the SMN protein. The detection antibody is labeled with an ECL label to permit electrochemiluminescence upon the proper electrical stimulation from the electrode connected substrate. In some embodiments, an illustrative detection antibody is a rabbit polyclonal anti-human SMN labeled with a caged ruthenium derivative. In one example, the anti-SMN2 capture antibody may be a 2B1 mouse monoclonal antibody and the anti-SMN2 detection antibody may be a rabbit anti-SMN polyclonal antibody. Further, the anti-SMN2 detection antibody may be tagged with an amine-reactive, N-hydroxysuccinimide ester linked to a caged ruthenium.

In one ECL immunoassay embodiment, a magnetic particle is conjugated to avidin or strepavidin. Next, a capture antibody such as anti-SMN clone 2B1 is conjugated to biotin. Next a whole blood cell lysate is added to the magnetic particle and capture antibody. Next, a detection antibody which specifically binds to SMN protein labeled with an ECL label such as a ruthenium derivative is added and the reaction permits a complex comprising capture antibody-SMN protein-detection antibody to form. Next the magnetic particles are added to the reaction and the complex specifically binds to the magnetic particles coated with avidin or streptavidin, permitting the unreacted reagents to be washed away. Next the magnetic particles are placed in proximal contact with a working and measuring electrode and in the presence of a developing reagent such as dibutyl ethanolamine and electrical stimulation, electrochemiluminescence emitted can be detected and measured. The extent of chemiluminescence is directly proportional to the amount of bound SMN.

In order to operate a system in which an electrode introduces electrochemical energy, it is necessary to provide an electrolyte in which the electrode is immersed. The electrolyte is a phase through which charge is carried by ions. Generally, the electrolyte is in the liquid phase, and is a solution of one or more salts or other species in water, an organic liquid or mixture of organic liquids, or a mixture of water and one or more organic liquids. However, other forms of electrolyte are also useful in certain embodiments of the invention. For example, the electrolyte may be a dispersion of one or more substances in a fluid, for example, a liquid, a vapor, or a supercritical fluid, or may be a solution of one or more substances in a solid, a vapor or supercritical fluid.

The electrolyte is suitably a solution of a salt in water. The salt can be a sodium salt or a potassium salt preferably, but incorporation of other cations is also suitable in certain embodiments, as long as the cation does not interfere with the electrochemiluminescent interaction sequence. The salt's anion may be a phosphate, for example, but the use of other anions is also permissible in certain embodiments of the invention—once again, as long as the selected anion does not interfere with the electrochemiluminescent interaction sequence.

The electrolyte is, in certain embodiments of the present disclosure, a buffered system. Phosphate buffers are often advantageous. Examples are an aqueous solution of sodium phosphate/sodium chloride, and an aqueous solution of sodium phosphate/sodium fluoride.

In some embodiments, a solid support material functions to provide a structure upon which the capture antibody can be attached. In these embodiments, the solid support material can also accommodate a pair of electrodes operable to apply an electrical potential waveform across an electrode surface, typically a metal surface, and a counterelectrode. In various embodiments, these solid support plates incorporate the above referenced electrodes (metallic or carbon) in the bottom of each well to enable high-performance electrochemiluminescence immunoassays. The solid support plates can include plates for both single and multiplex assays; including standard 96-well and 384-well formats. In various embodiments, the solid support plates can include a surface that permits conjugation of an antibody using known coupling chemistries, or plates that are coated with avidin, streptavidin, glutathione, or any other convenient coupling system.

The solid support used for immobilization may be any inert support or carrier that is essentially water insoluble and useful in immunoassays, including supports in the form of, e.g., surfaces, particles, porous matrices, etc. Examples of commonly used supports include including 96-well microtiter plates, as well as particulate materials such as filter paper, agarose, cross-linked dextran, and other polysaccharides. The solid support can be coated with the capture antibody as defined above, which may be linked by a non-covalent or covalent interaction or physical linkage as desired. Techniques for attachment include those described in U.S. Pat. No. 4,376,110 and the references cited therein. If covalent, the plate or other solid support is incubated with a cross-linking agent together with the capture reagent under conditions well known in the art such as for one hour at room temperature.

Commonly used cross-linking agents for attaching the capture reagents to the solid-phase substrate include, e.g., 1,1-bis(diazoacetyl)-2-phenylethane, glutaraldehyde, N-hydroxysuccinimide esters, for example, esters with 4-azidosalicylic acid, homobifunctional imidoesters, including disuccinimidyl esters such as 3,3′-dithiobis(succinimidylpropionate), and bifunctional maleimides such as bis-N-maleimido-1,8-octane. Derivatizing agents such as methyl-3-((p-azidophenyl)-dithio)propioimidate yield photoactivatable intermediates capable of forming cross-links in the presence of light.

In an illustrative embodiment, if 96-well plates are utilized, they are preferably coated with the mixture of capture antibody typically diluted in a buffer such as 0.05 M sodium carbonate by incubation for at least about 10 hours, more preferably at least overnight, at temperatures of about 4-20° C., more preferably about 4-8.degree° C., and at a pH of about 8-12, more preferably about 9-10, and most preferably about 9.6. If shorter coating times (1-2 hours) are desired, one can use 96-well plates with nitrocellulose filter bottoms (Millipore MULTISCREEN®) or coat at 37° C. The plates may be stacked and coated long in advance of the assay itself, and then the ECL SMN immunoassay can be carried out simultaneously on several samples in a manual, semi-automatic, or automatic fashion, such as by using robotics.

In one embodiment, the capture antibody coated plates are then typically treated with a blocking agent that binds non-specifically to and saturates the binding sites to prevent unwanted binding of the free ligand to the excess sites on the wells of the plate. Examples of appropriate blocking agents for this purpose include, e.g., gelatin, bovine serum albumin, egg albumin, casein, and non-fat milk. The blocking treatment typically takes place under conditions of ambient temperatures for about 1-4 hours, preferably about 1.5 to 3 hours.

After coating and blocking, the standard (for example, human SMN2 or human SMN1) or the WBL or CSF sample to be analyzed, can be appropriately diluted, is then added to the immobilized phase. The preferred dilution rate is about 5-15%, preferably about 10%, by volume. Buffers that may be used for dilution for this purpose include (a) phosphate-buffered saline (PBS) containing 0.5% BSA, 0.05% TWEEN 20® detergent (P20), 0.05% PROCLIN® 300 antibiotic, 5 mM EDTA, 0.25% 3-((3-cholamidopropyl)dimethylammonio)-1-propanesulphonate (CHAPS) surfactant, 0.2% beta-gamma globulin, and 0.35M NaCl; (b) PBS containing 0.5% bovine serum albumin (BSA), 0.05% P20, and 0.05% PROCLIN® 300, pH 7; (c) PBS containing 0.5% BSA, 0.05% P20, 0.05% PROCLIN® 300, 5 mM EDTA, and 0.35 M NaCl, pH 6.35; (d) PBS containing 0.5% BSA, 0.05% P20, 0.05% PROCLIN® 300, 5 mM EDTA, 0.2% beta-gamma globulin, and 0.35 M NaCl; and (e) PBS containing 0.5% BSA, 0.05% P20, 0.05% PROCLIN® 300, 5 mM EDTA, 0.25% CHAPS, and 0.35 M NaCl.

The amount of capture antibody employed is sufficiently large to give a good signal in comparison with the standards, but not in molar excess compared to the maximum expected level of SMN protein in the sample. For sufficient sensitivity, it is preferred that the amount of WBL or CSF sample added be such that the immobilized capture antibody is in molar excess of the maximum molar concentration of free SMN protein anticipated in the WBL or CSF sample after appropriate dilution of the WBL or CSF sample (for example, whole blood lysate). This anticipated level depends mainly on any known correlation between the concentration levels of the SMN protein in the particular WBL or CSF sample being analyzed with the clinical condition of the patient. Thus, for example, an adult SMA patient may have a maximum expected concentration of SMN protein in his/her WBL or CSF that is quite low, or even bordering on the detection limits whereas a control, non-SMA subject will be expected to have a higher level of SMN protein in his/her WBL.

While the concentration of the capture antibody will generally be determined by the concentration range of interest of the SMN protein in the WBL or CSF sample, taking any necessary dilution of the WBL or CSF sample into account, the final concentration of the capture antibody will normally be determined empirically to maximize the sensitivity of the assay over the range of interest. However, as a general guideline, the molar excess is suitably less than about ten-fold of the maximum expected molar concentration of SMN protein in the WBL or CSF sample after any appropriate dilution of the sample. In other embodiments, employing a secondary antibody that binds to the SMN protein captured by the capture antibody and using a detection antibody conjugated to an ECL label that specifically binds to the secondary antibody can further increase the sensitivity and/or limit of detection of the SMN ECL immunoassay.

The conditions for incubation of WBL or CSF sample and immobilized capture antibody are selected to maximize sensitivity of the assay and to minimize dissociation, and to ensure that any SMN protein present in the sample binds to the immobilized capture antibody. Preferably, the incubation is accomplished at fairly constant temperatures, ranging from about 0° C. to about 40° C., preferably at or about room temperature. The time for incubation is generally no greater than about 10 hours. Preferably, the incubation time is from about 0.5 to 3 hours, and more preferably about 1.5-3 hours at or about room temperature to maximize binding of SMN protein to the capture reagents. The duration of incubation may be longer if a protease inhibitor is added to prevent proteases in the WBL or CSF sample (e.g. WBL) from degrading the SMN protein in the whole blood or CSF sample.

At this stage, the pH of the incubation mixture will ordinarily be in the range of about 4-9.5, preferably in the range of about 6-9, more preferably about 7 to 8. The pH of the incubation buffer is chosen to maintain a significant level of specific binding of the capture antibody to the SMN protein being captured. Various buffers may be employed to achieve and maintain the desired pH during this step, including borate, phosphate, carbonate, TRIS-HCl or TRIS-phosphate, acetate, barbital, and the like. The particular buffer employed is not critical to the invention, but in individual assays one buffer may be preferred over another.

Optionally, the WBL or CSF sample is separated (preferably by washing) from the immobilized capture antibody to remove uncaptured SMN protein and other protein species which may cross-react. The solution used for washing is generally a buffer (“washing buffer”) with a pH determined using the considerations and buffers described above for the incubation step, with a preferable pH range of about 6-9. The washing may be done three or more times. The temperature of washing is generally from refrigerator to moderate temperatures, with a constant temperature maintained during the assay period, typically from about 0-40° C., more preferably about 4-30° C. For example, the wash buffer can be placed in ice at 4° C. in a reservoir before the washing, and a plate washer can be utilized for this step.

The immobilized capture antibody with any bound SMN protein present is contacted with a detection antibody, preferably at a temperature of about 18-40° C., more preferably about 36-38° C., with the exact temperature and time for contacting the two being dependent primarily on the detection means employed.

The level of any SMN protein from the subject's WBL or CSF sample that is now bound to the capture antibody is determined using ECL correlated to the amount of detection antibody labeled with an ECL label bound to the SMN protein captured by the capture antibody. If the WBL or CSF sample is from a clinical patient, the measuring step preferably comprises comparing the reaction that occurs as a result of the above steps with a standard curve to determine the level of SMN protein compared to a known amount.

The secondary antibody added to the immobilized capture antibody will be either directly labeled with an ECL label (detection antibody), or detected indirectly by addition, of a molar excess of a detection ECL labeled antibody directed against IgG of the animal species of the secondary antibody.

Following the addition of the detection antibody, the amount of bound detection antibody is determined by removing excess unbound detection antibody through washing and then measuring the amount of the attached ECL label using a detection method appropriate to the label, and correlating the measured amount with the amount of SMN protein in the WBL or CSF sample, using for example a standard curve of SMN of interest using the ECL immunoassay of the present disclosure.

The present disclosure provides methods for determining the levels of SMN protein in WBL or CSF samples using electrochemiluminescence. Several advantages are provided to using electrochemiluminescence over ELISA methods, including using WBL as the tested sample. In one embodiment, the electrochemiluminescence immunoassay detects survival motor neuron 2 (SMN2) protein or a aberrantly spliced form thereof, using an anti-SMN2 capture antibody and an anti-SMN2 detection antibody in WBL. The use of whole blood as a biological example, affords ease of sampling and affords high throughput, in particular during clinical drug testing by obviating the need to separately isolate certain cell types or tissue for SMN protein analysis. The ability to utilize very small volumes of whole blood as the biological sample in the present methods also affords the ability to sample infants and very young children who may not be able to give sufficient volumes of whole blood for subcellular fractionation and isolation of PMBC sufficient for reliable ELISA based SMN determinations.

In various embodiments of the present disclosure SMN protein can be detected using any anti-SMN2 or anti-SMN1 antibody or fragment thereof that is able to bind to epitopes found in the amino acid sequence of SMN 1 and SMN2 that is not part of the encoded exon 7 region. In some of these embodiments, the region of SMN1 and SMN2 that are recognized and which bind to the capture antibody and detection antibody include from amino acid 1 to amino acid 220 in the human SMN protein of SEQ ID NO: 1 & 2. In some embodiments, both the capture antibody and the detection antibody are operable to bind to SMN protein without interfering with each other's ability to specifically bind to SMN. In some embodiments, the capture antibody or the detection antibody binds to epitopes between amino acids 14-20 or the capture antibody or the detection antibody binds to epitopes between amino acids 197-204 in the human SMN protein set forth in SEQ ID NO: 1 & 2

In another aspect, the inventive method includes provision of an electrochemiluminescence reader for electrochemically stimulating the ECL label or TAG; and using the reader to detect the level of SMN1 and/or SMN2 in a WBL or CSF sample in accordance with the methods described herein.

In one embodiment, the SMN ECL immunoassay detects survival motor neuron 2 (SMN2) protein in a WBL or CSF sample. Because a patient diagnosed with SMA produces little or no functional SMN1 protein, protein expression levels of SMN2 can used to determine the SMA type of a subject (diagnosis), SMA progression in a subject, and the efficacy in a subject of an agent that has been approved for the treatment of SMA. The ability to detect SMN2 in WBL or CSF also provides a convenient source for evaluating SMN content from subjects during clinical trials.

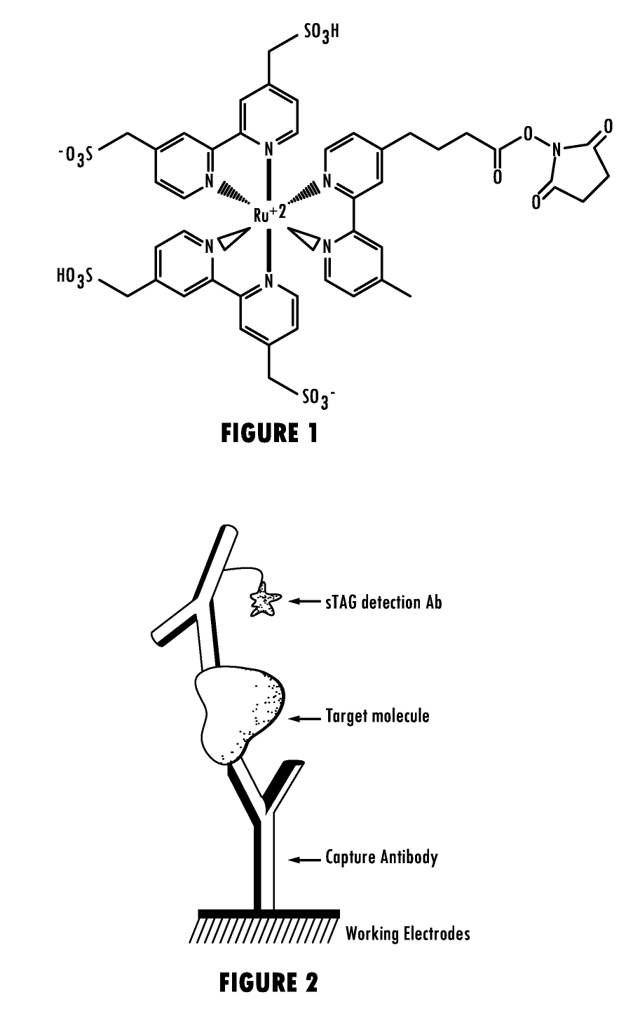

In a further embodiment, the SMN ECL immunoassay of the present disclosure includes an anti-SMN2 capture antibody and an anti-SMN2 detection antibody. For example, as described in the Examples section below, the anti-SMN2 capture antibody is a 2B1 mouse monoclonal antibody (produced by Enzo Life Sciences, Farmingdale, N.Y., USA, Cat. No. ADI-NBA-202-050), the anti-SMN2 detection antibody is a rabbit polyclonal antibody (Cat. No. 11708-1-AP, Protein Tech, Chicago, Ill., USA), and the anti-SMN2 detection antibody is tagged with an amine-reactive, N-hydroxysuccinimide ester linked to a caged ruthenium (a Sulfo-tag) produced by Meso Scale Discovery (MSD) (See FIG. 1).

In ECL, the incubated sample is exposed to a voltammetric working electrode, i.e., an electrode to which a voltage is applied and into which a current for a redox reaction is passed. The ECL mixture does not react with the chemical environment alone, as does the chemiluminescence mixture, or with an electric field alone, as in electrochemistry, but rather electrochemiluminescence is triggered by a voltage impressed on the working electrode at a particular time and in a particular manner to controllably cause the ECL sample to emit light at the electrochemiluminescent wavelength of interest. The measurement is not the current at the electrode, as in electrochemistry, but the frequency and intensity of emitted light which correlates to the amount of bound complex present in the WBL or CSF sample being tested.

Sulfo-tagged antibodies can be prepared, for example, using the methods described by MSD in “MSD Sulfo-Tag NHS Ester”, 17794-v3-2011January, which is incorporated herein by reference.

In the above-described method, a blocker (Blocker DM) is added during the assay steps to decrease background and prevent non-specific interaction of the rabbit polyclonal antibody with the 2B1 antibody, and to decrease background and prevent non-specific interaction of the rabbit polyclonal antibody with the goat anti-rabbit antibody, respectively.

A read buffer is added to react with the amine-reactive, N-hydroxysuccinimide ester linked to a caged ruthenium (Sulfo-tag; Meso Scale Discovery (MSD)) on the primary and secondary detection antibodies. MSD read buffers contain coreactants that enhance the electrochemiluminescence signals. These coreactants also are stimulated when in proximity to the electrodes in the microplate.

Also, an electrochemiluminescence reader is provided to electrochemically stimulate the Sulfo-tag and detect the level of SMN2 in the WBL sample (and the standard cloned SMN). Two such electrochemiluminescence readers are the Sector Imager 6000 or 2400 readers manufactured by MSD. (See FIG. 2).

In some embodiments, the steps of the inventive method and the reagents used may be varied to improve the effectiveness of the assay for samples or the conditions presented. For example, the dilution of WBL to determine SMN protein content is a variable that can only be approximated. The inventors determined the content of SMN protein in WBL samples from normal individuals by diluting the WBL 1:40. However, WBL from a Type I patient (most likely containing lower amounts of SMN) may need to be diluted at a 1:20 dilution to make sure that the signal from a 1:20 diluted sample falls within the range of the standard curve using purified and cloned SMN from E. coli as a standard. Another assay parameter that might be varied is first diluting frozen blood in buffer containing detergent such as Triton-100 and salt (NaCl) to affect a better recovery of endogenous SMN. Other combinations that could be used for the purpose of diluting blood or WBL would include, for example, a salt and other non-denaturing detergents, such as, Tween 20 or chaps. In some embodiments of the methods for determining SMN in a whole blood sample, the WBL obtained from the whole blood sample is diluted 1:2, or 1:5, or 1:10, or 1:20, or 1:30, or 1:40, or 1:50, or 1:75, or 1:100, or 1:150, or 1:200, and values therebetween prior to adding to the ECL immunoassay solid support.

The inventive methods, described hereinabove, can be used to detect SMN protein in WBL or CSF samples in addition to other biological samples including, whole blood, plasma, serum, and fractionated blood fractions containing contaminating WBL.

In order to provide standards for establishing differential expression, normal and disease expression profiles are established. This is accomplished by combining a sample taken from normal subjects, either animal or human, with a cDNA under conditions for hybridization to occur. Standard hybridization complexes may be quantified by comparing the values obtained using normal subjects with values from an experiment in which a known amount of a purified sequence is used. Standard values obtained in this manner may be compared with values obtained from samples from patients who were diagnosed with a particular condition, disease, or disorder. Deviation from standard values toward those associated with a particular disorder is used to diagnose that disorder.

Such SMN ECL immunoassays of the present disclosure may also be used to evaluate the efficacy of a particular therapeutic treatment regimen in animal studies or in clinical trials or to monitor the treatment of an individual patient. Once the presence of a condition is established and a treatment protocol is initiated, diagnostic assays may be repeated on a regular basis to determine if the level of expression in the patient begins to approximate that which is observed in a normal subject. The results obtained from successive assays may be used to show the efficacy of treatment over a period ranging from several days to years.

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the claims.

### EXAMPLES

### Example 1

### ECL Protocol For Determining the Level of SMN Protein From WBL

1. Wet MSD plate (having electrodes integrated into the bottom of the plate, MSD Sector® Plate, Cat. No. L15XA-3 or L15XB-3) with 100 μl of phosphate buffered saline (PBS) and shake for 1 minute.
2. Add anti-SMN (2B1) antibody (Enzo Life Sciences, Farmingdale, N.Y., USA, Cat. No. ADI-NBA-202-200)—stock concentration at 1.0 mg/ml, dilute 1:1000 in PBS yielding a working stock of 1.0 μg/ml; coat wells by adding 30 μl of the 1.0 μg/ml anti-SMN 2B1 antibody and shake for 10-15 sec followed by checking with light for even coating; seal plate and incubate overnight at 4° C.
3. Flick anti-SMN 2B1 antibody out of the MSD plate and block the plate with 5% Bovine Serum Albumin (BSA); 0.05% Tween 20 in PBS (100 μl/well) for 30 minutes to one hour at 650 rpm at room temperature.
4. Wash MSD plate 3× with 200 μl wash buffer (wash buffer: 50 mM Tris, pH 7.5; 150 mM NaCl; 0.05% Tween 20).
5. Add 25 μl of whole blood lysate sample or standard cloned SMN per well in 1% BSA; 0.05% Tween 20 and incubate for 2 hours with shaking. To prepare 1% BSA, dilute the 5% BSA stock solution 1:5.
6. Flick the MSD plate. Wash plate 3× with 200 μl wash buffer.
7. Primary detection antibody (a Sulfo-tagged rabbit polyclonal anti-SMN2 antibody, Cat. No. 11708-1-AP, Protein Tech, Chicago, Ill., USA): dilute 1:1000 with 1% BSA; 0.05% Tween 20; 0.1% Blocker DM (mouse gamma globulin); 25 μL/well; seal plate and incubate 1 hour with shaking at 650 rpm at room temperature.
8. Flick the plate. Wash plate 3× with 200 μl wash buffer.
9. Secondary detection antibody (a Sulfo-tagged goat anti-rabbit antibody) dilute 1:1000 with 1% BSA; 0.05% Tween 20; 0.1% Blocker DM; 25 μL/well; seal plate and incubate for 30 minutes at 650 rpm at room temperature.
10. Flick the plate. Wash plate 3× with 200 μl of wash buffer.
11. Add 150 μl/well of 1×MSD read buffer and read plate within about 5 minutes to detect SMN2 levels.

### Example 2

### Materials

| Material/Product | Supplier | C/N |
|---|---|---|
| Standard Plate | Mesoscale Discovery | L15XA-3 |
| Bovine Serum Albumin | SeraCare | AP-4510-01 |
| 4X Read Buffer | Mesoscale Discovery | R92TC-2 |
| Blocker D-M | Rockland | D609-0100 |
| 1X PBS | Gibco | 10010-023 |
| Tween 20 | Sigma | P1379 |
| Tris (base) | J T Baker | 4109-01 |
| Sodium Chloride | Sigma-Aldrich | S-1679-500G |
| Triton X-100 | Sigma | T8787 |
| Sterile Water for Irrigation | Baxter | 2F7114 |
| 2B1Antibody | ENZO | ADI-NBA-202-200 |
| Sulfo-Tag | Meso Scale Discovery | R91AN-1 |
| Rabbit α-SMN Antibody | Protein Tech | 11708-1-AP |
| ST-Goat α-Rabbit | Meso Scale Discovery | R32AB-1 |
| Antibody | | |
| SMN Calibrator, human | ENZO | NBP-201 |
| (Standard) | | |

### Example 3

### Methods for SMN Electrochemiluminesence (ECL) Immunoassay

Requires overnight solution-coating of Meso Scale Discover (MSD) Standard Plate (MSD Sector® Plate, Cat. No. L15XA-3 or L15XB-3) with an assay incubation time of 4.5 hours.

Solution-Coat Standard Plate with Capture Antibody

100 μL/well 1×PBS, pH 7.4 to pre-wet well surface
Incubate 5 minutes at RT
While plate is pre-wetting prepare Capture Antibody:

Capture Antibody 1 μg/mL (2B1 - mouse monoclonal Ab)

| | |
|---|---|
| ✓ | Capture Antibody: 3 mL volume needed for 1 plate |

| | |
|---|---|
| 3 μL | 1 mg/mL Mouse anti-SMN 2B1 antibody |
| 3 mL | 1X PBS, pH 7.4 |

After 5 minutes, flick off pre-wetting buffer; don't blot
30 μL/well 1 μg/mL Capture Antibody
Verify using direct light source that liquid is distributed evenly across the well surface
Seal plate and incubate overnight at 4° C.

Blocker A Preparations-5%& 1%

5% Blocker A - used for blocking plate only

| | |
|---|---|
| ✓ | 5% BSA; 1X PBS; 0.05% Tween 20 |

| | |
|---|---|
| 2.5 g | Bovine Serum Albumin |
| 50 mL | 1X PBS, pH 7.4 |
| 25 μL | Tween 20 |

1% Blocker A - used for dilutions

| | |
|---|---|
| ✓ | 1% BSA; 1X PBS; 0.05% Tween 20 |

| | |
|---|---|
| 10 mL | 5% Blocker A |
| 40 mL | 1X PBS, pH 7.4 |
| 20 μL | Tween 20 |

Block Plate

Flick off Capture Antibody; don't blot

### 80 μL/well 5% Blocker A

Seal plate and incubate 0.5-1 hr at 650 rpm at RT
While blocking make Standards and Samples

Standard Curve—Stock @ 1.5 μg/mL←example of stock [1% BSA; 1×PBS, pH 7.4; 0.1% Triton X-100]

### Diluent: 1% Blocker A

| | | | | | |
|---|---|---|---|---|---|
| | | Standard | Standard | | Diluent |
| Sample ID | pg/mL | μL | ID | ✓ | μL |

| | | | | |
|---|---|---|---|---|
| Std 1 | 10,000 | 5 | 1.5 μg/mL | 745 |
| Std 2 | 2000 | 200 | Std 1 | 800 |
| Std 3 | 400 | 100 | Std 2 | 400 |
| Std 4 | 80.0 | 100 | Std 3 | 400 |
| Std 5 | 16.0 | 100 | Std 4 | 400 |
| Std 6 | 3.20 | 100 | Std 5 | 400 |
| Std 7 | 0.640 | 100 | Std 6 | 400 |
| Std 8 | 0 | 0 | Std 7 | 400 |

Sample Dilutions—Suggested Dilutions for Sample Type

### Diluent: 1% Blocker A

| Sample | Suggested | Sample | Diluent |
|---|---|---|---|
| Type | Dilutions | (μL) | (μL) |
| CSF | 1:5 | 5 | 20 |
| *Whole Blood | 1:20 | 10 | 190 |
| Lysate | 1:40 | 10 | 390 |
| PBMCs | 1:20 | 10 | 190 |
| Platelets | 1:10 | 20 | 180 |
| | 1:50 | 5 | 245 |
| | 1:100 | 5 | 495 |
| Reticulocytes | 1:2 | 50 | 50 |
| | 1:5 | 20 | 80 |
| | 1:10 | 10 | 90 |

*All Whole Blood Lysate samples, including samples depleted of platelets, PBMCs, reticulocytes

Addition of Samples and Standards to Solution-Coated Assay Plate

### Wash Buffer: 50 mM Tris, pH 7.5; 150 mM NaCl; 0.05% Tween 20

Flick off 5% Blocker A; blot
200 μL/well wash with Wash Buffer×3 washes; blot between each wash

### 25 μL/well Standard or Sample per Plate Map

Seal plate and incubate 2 hrs at 650 rpm at RT
Prepare 2° Antibody towards end of incubation time

2° Antibody (§ST-Rabbit α-SMN; stock 1.1 mg/mL)←example of stock

2° Antibody - [2 μg/mL ST-Rabbit α-SMN]

| | | |
|---|---|---|
| ✓ | μL | Reagent |

| | |
|---|---|
| 150 | 2% D-M Blocker |
| 2845 | 1% Blocker A |
| 5.46 | ST-Rabbit α-SMN Ab @ 1.1 mg/mL |

§ST-Rabbit α-SMN Sulfo-tagged per manufacturer's instructions
Flick off Standards and Samples; blot
200 μL/well wash with Wash Buffer×3 washes; blot between each wash

### 25 μL/well 2o Antibody

Seal plate and incubate 1 hr at 650 rpm at RT
Prepare Sulfo-tag Goat α-Rabbit Antibody Dilution towards end of incubation time

3° Antibody (ST-Goat α-Rabbit; stock 0.5 mg/mL)→example of stock

3° Antibody - [0.5 μg/mL ST-Goat α-Rabbit]

| | | |
|---|---|---|
| ✓ | μL | Reagent |

| | |
|---|---|
| 3000 | 1% Blocker A |
| 3 | ST-Goat α-Rabbit Antibody Stock (0.5 mg/mL) |

Flick off 2° Antibody; blot
200 μL/well wash with Wash Buffer×3 washes; blot between each wash

### 25 μL/well 3° Antibody

Seal plate and incubate 0.5 hr at 650 rpm at RT
Prepare 1×MSD Read Buffer towards end of incubation time

1×MSD Read Buffer

1X MSD Read Buffer

| | | |
|---|---|---|
| ✓ | mL | Reagent |

| | |
|---|---|
| 12 | Sterile Water for Irrigation |
| 4 | 4X MSD Read Buffer |

Flick off 3° Antibody; blot
200 μL/well wash with Wash Buffer×3 washes; blot between each wash
150 μL/well 1×MSD Read Buffer (Reverse Pipetting—to avoid bubbles)
Read plate with MSD Reader within 5 minutes to detect SMN levels

### Example 4

### Results

Comparison of SMN Detection Methods in Assay Buffer

| Variables | ECL | ENZO(ELISA) |
|---|---|---|
| Assay Sensitivity | 2-3 pg/mL | 50 pg/mL |
| Matrix Effects | Low | High |
| Sample Volume | Low (<25 μL) | 100 μL |

### Example 5

### Comparison Of Standard Curves and Mouse and Human Test Samples Using ECL And ELISA Based Detection Protocols

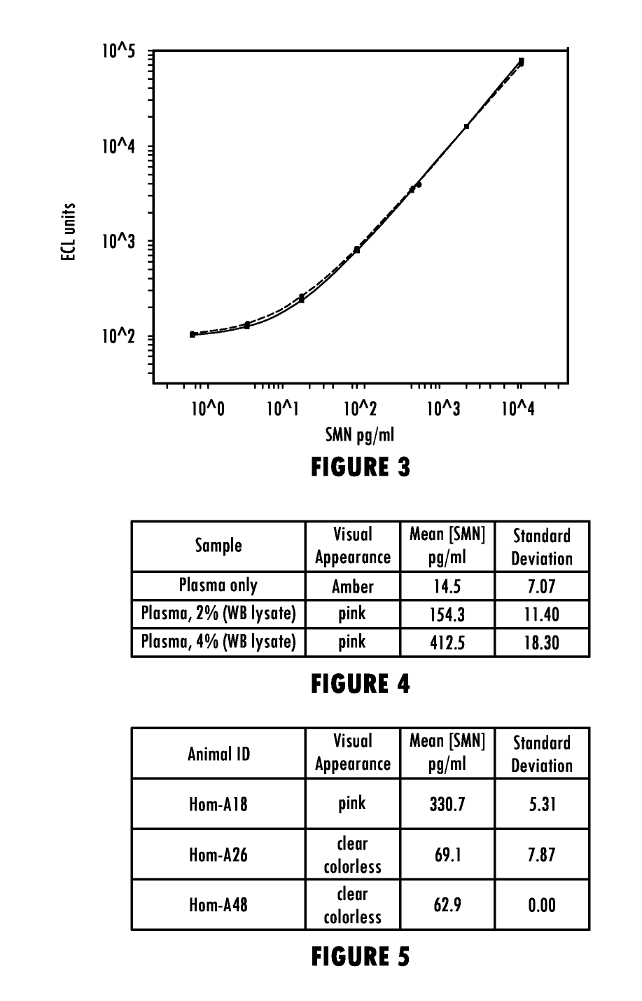

In one experiment, SMN-ECL assay characteristics were analyzed as follows: ECL assay commercially available from Meso Scale Discovery was tested using standard concentrations of human SMN2. In the analysis, the capture antibody was mouse monoclonal (2B1) anti-human SMN; the detection antibody was rabbit polyclonal anti-human SMN; the sensitivity had lower limits of detection of 2-3 pg/ml; the dynamic range was 3-10,000 pg/ml; the assay time was 3-4 h; and the format was a 96 well plate. FIG. 3 shows very tight dispersion and highly reproducible results using human SMN2 standards.

In a second experiment, levels of SMN were analyzed using the ECL immunoassay of the present disclosure in mouse serum with and without whole blood lysate. As shown in FIG. 4, whole blood lysate contamination dramatically increases the SMN levels in C/C mouse plasma. The inventors determined that plasma samples contaminated with whole blood lysate showed an increased amount of SMN and that increase varied directly with the amount of whole blood lysate present in the tested sample. When the inventors spiked a clean-looking plasma sample with 2% v/v or 4% v/v of whole blood, the signal or SMN level significantly increased. The signal was coming from SMN in whole blood lysate, thus confirming a suitable sample for routine and multiplexed SMN determination using ECL immunoassays.

During the course of assay development it was noted that plasma with a distinct pink color and thus WBL contamination, had significantly higher levels of SMN compared to amber colored plasma samples (plasma samples with minimal or no WBL contamination). Plasma spiked with red blood cell lysate had significantly higher levels of SMN. Whole blood, subjected to freeze thaw in order to lyse the cells, thereby creating a whole blood lysate, had levels of SMN approaching 90 ng/mL in whole blood of wild type mice and 5-10 ng/mL in human whole blood. Use of a ficoll gradient to separate PBMCs from red blood cells in mouse whole blood demonstrated that greater than 99% of the SMN protein detected was from the red blood cell fraction. Spike recovery studies in mouse whole blood lysate demonstrated an 87-99% recovery of SMN. Dilutional analysis of whole blood lysate resulted in a curve parallel in nature to the standard curve for both human and mouse whole blood, thus no sample-matrix effect on the measurement of SMN in whole blood using the ECL method was observed. Whole blood samples subjected to freeze thaw maintained SMN levels compared to non-freeze thaw samples. The ECL method was applied to measure SMN level in whole blood of a SMA mouse model and SMA patients. Comparison of SMN levels in the whole blood of wild type, heterozygous and homozygous C/C mice resulted in statistically significant differences between genotypes. Human whole blood from SMA carriers, Type II and Type III SMA patients demonstrated statistically significant differences between carriers and Type II patients.

The plasma contamination result was further confirmed using C/C mouse cerebral spinal fluid (CSF). FIG. 5 shows the effect of whole blood contamination on SMN levels in C/C mouse cerebral spinal fluid (CSF). More specifically, FIG. 5 demonstrates that mouse cerebral spinal fluid contaminated with whole blood lysate (as evidenced by the pink color) showed a much higher amount of SMN. The mice used were homozygous C/C mice (mouse model of spinal muscular atrophy). Whole blood lysate contamination increased SMN as measured by the ECL immunoassay of the present disclosure. This was further evidence that whole blood lysate contamination increased SMN content in the sample.

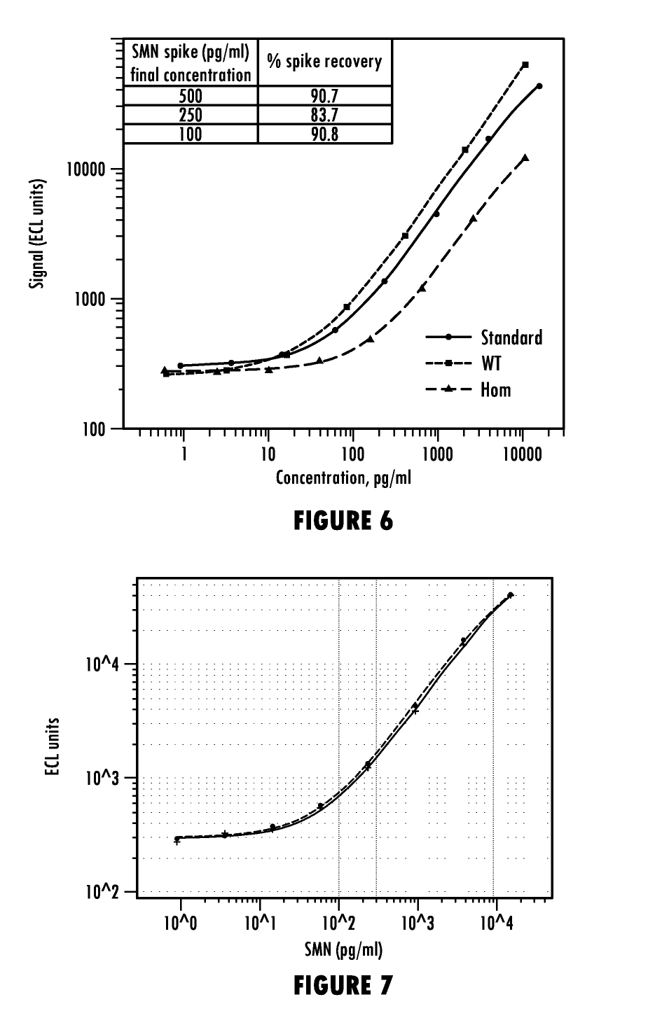

In a further experiment, the ECL immunoassay of the present disclosure was analyzed to determine whether the use of whole blood lysate could be scaled and to determine the dynamic range of detection when compared against a known standard curve of SMN2 protein. As shown in FIG. 6, dilutions of purified SMN standard (SMN Calibrator, human (Standard) ENZO Life Sciences Cat. No. NBP-201provided in the ENZO ELISA SMN kit) showed parallelism with mouse whole blood lysate serially diluted. This indicated that the SMN in whole blood lysate was reacting with anti-SMN capture and detection antibodies in an identical manner with purified SMN standard. Additionally, SMN standard spiked into the mouse blood showed good recovery (without losing ability to measure SMN in the blood sample).

To determine the effect of freezing and thawing a whole blood sample on the detection and quantification of SMN using the SMN ECL immunoassays of the present disclosure, mouse extracted whole blood and mouse whole blood lysate formed from a single freeze/thaw procedure was used in parallel using an ECL immune assay in accordance with the examples set forth herein. FIG. 7 is a line graph comparing two mouse whole blood dilution curves following a single freeze/thaw. One curve is no freeze/thaw and the other is freeze/thaw thereby creating a whole blood lysate. FIG. 7 shows that freezing the blood sample did not interfere or destroy the SMN in the blood (i.e., good sample preservation).

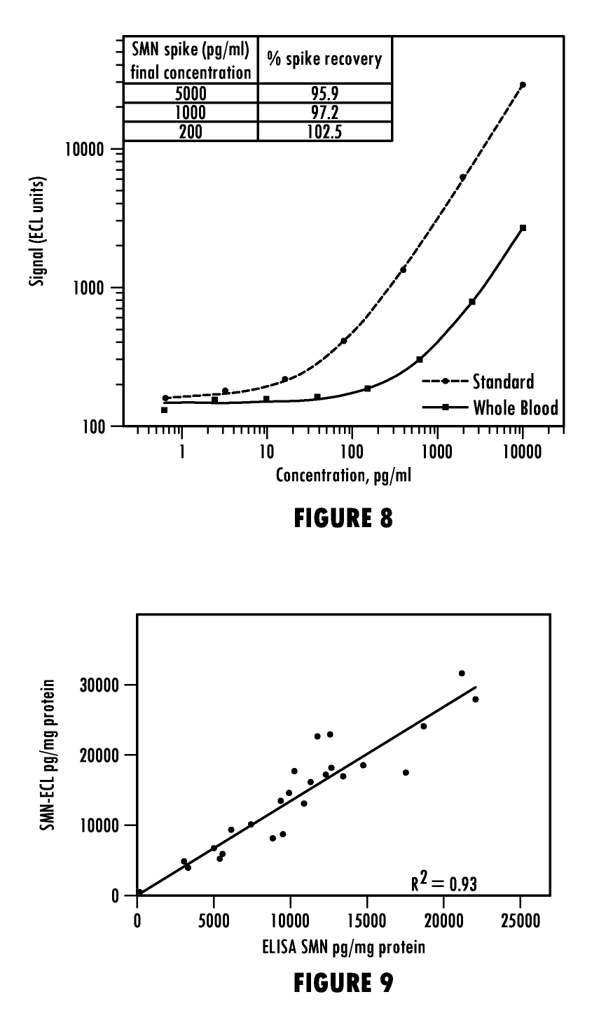

In another experiment, increasing dilutions of whole blood lysate was directly compared to varying amounts of standard human SMN using the SMN ECL immunoassays of the present disclosure. As shown in FIG. 8, parallelism is demonstrated between an SMN standard curve and a human whole blood dilution curve. More specifically, FIG. 8 shows parallelism and good spike recovery in human blood (the same points as described in FIG. 6 with mouse blood).

When comparing the linearity of the ECL immunoassay methodology of the present disclosure to the standard ELISA based method, the ECL immunoassay described herein provides reliable comparative calculations when compared to the ELISA method with the added convenience of using 1/10 the volume of patient sample. FIG. 9 is a comparison of SMN quantification using an illustrative SMN ECL assay as described herein using the Meso Scale Discovery ECL kit and Meso Scale Discovery ECL reader, and compared to the ENZO ELISA using purified peripheral blood mononuclear cells (PBMCs) as the sample. Purified PBMCs from whole blood have been shown to contain SMN. The SMN ECL assay of the present disclosure detected slightly more SMN from a given PBMC sample than the ELISA and may be due to a more efficient recognition of SMN on the plate surface by the SMN antibody. The SMN ECL immunoassay gave very similar results to the commercially available ELISA for PBMC SMN. However, the ELISA cannot be accurately used to detect SMN using a WBL sample because of high background interference, thus giving the ECL based immunoassay an unexpected advantage in being able to use whole blood as the sample for routine SMN protein determination.

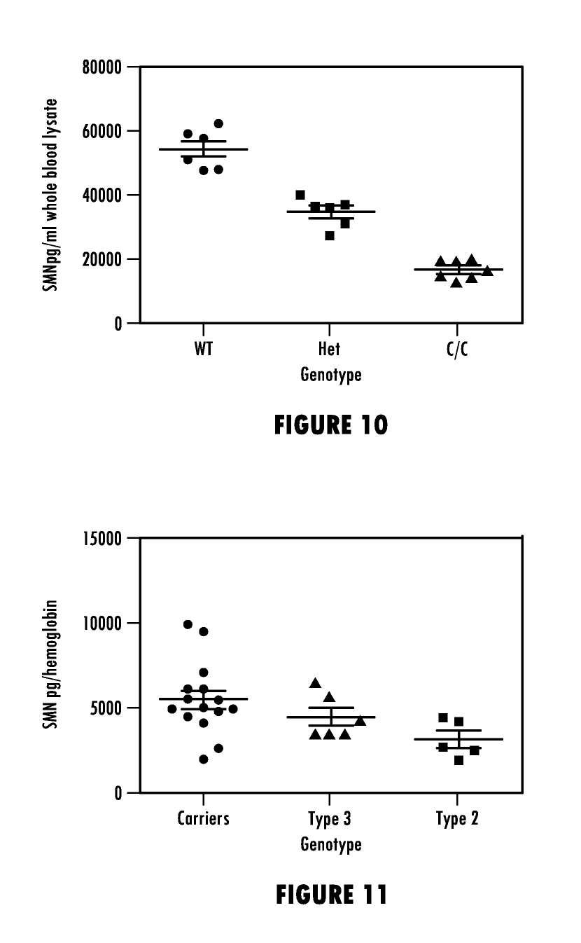

In addition to the convenience afforded by the use of whole blood as a routine sample for determining levels of SMN, the present disclosure also provides methods useful in discriminating between normal and SMA patients and those who are carriers of the defective gene. In particular, FIG. 10 demonstrates that the SMN ECL immunoassay of the present disclosure can measure and show differences in SMN levels from whole blood lysate samples in wild type (WT), heterozygous (Het), and homozygous (C/C) mice. Further, this data demonstrates that a whole blood assay can be used to measure differences in SMN expression based on genotype and that this assay could be used to test the effect of a drug on SMN expression in a homozygous genotype.

Further experiments were carried out to not only determine the suitability of the SMN ECL immunoassay of the present disclosure to distinguish between affecteds and non-affected, but to also determine whether the immunoassays described herein, can differentiate between Type 2 SMA phenotypes from Type 3 phenotypes and carriers of the defective SMN gene. Unexpectedly, the SMN ECL immunoassay of the present disclosure can in fact subtly detect differences between these patient subpopulations. Human whole blood lysate from SMA carriers, and from Type II and Type III SMA patients demonstrated statistically significant differences between carriers and Type II patients. This difference was not seen using PBMCs from the same samples. The SMN ECL immunoassay employing whole blood lysate as the sample for SMN determination quantitated statistically different SMN expression in Type II SMN patients from heterozygous carriers. See, SMA 2011-096: Collection, processing, and ELISA analysis of SMN from peripheral blood mononuclear cells (PBMC) from SMA (spinal muscular atrophy) patients enrolled in a pilot study at Jasper Clinic; and “Evaluation of Peripheral Blood Mononuclear Cell Processing and Analysis for Survival Motor Neuron Protein” (Crawford et al 2012) PLOS ONE November 2012, Volume 7, Issue 11, e50763.

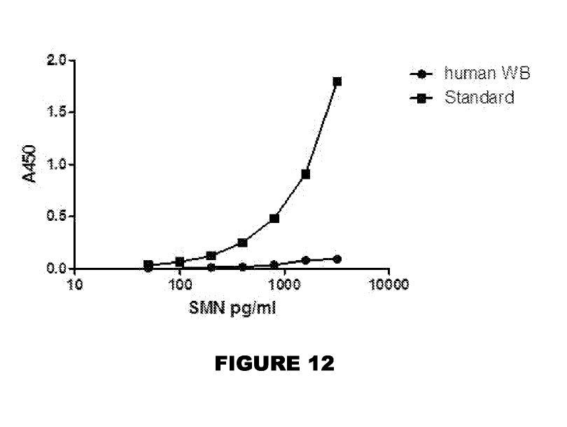

To determine whether the effect of using whole blood lysate was particularly problematic for ELISA based assays for the determination of SMN, two standard curves were compared using the ENZO Life Science SMN assay which is the standard SMN quantification test used in the art. Standard curves employing human SMN (SMN Calibrator human standard Cat. No. NBP-201, ENZO Life Science, Farmingdale, N.Y., USA) and whole blood lysate diluted directly into assay buffer using the ELISA method were compared. As shown in FIG. 12, the ELISA based quantification method cannot appropriately determine the amount of SMN in the whole blood lysate. The use of whole blood as a test sample for the determination of SMN levels in subjects cannot be effectively performed using ELISA based systems, unless the whole blood is diluted to such a great extent to prevent interference from the blood matrix, which then dilutes the amount of SMN in the tested sample beyond the sensitivity of the ELISA assay yielding inaccurate results. (See for example, the comparison between the standard curve of FIG. 8 using an SMN ECL immunoassay of the present disclosure to the standard curve of FIG. 12 using an ELISA based quantification method using whole blood lysate as a biological sample.

In various embodiments of the present disclosure, the sensitivity of the SMN ECL immunoassays described herein are statistically higher than what is observed using ELISA based methods using whole blood samples. For example, the SMN ECL immunoassays described herein have a sensitivity of about 0.1 to about 15 pg/mL of SMN in a whole blood lysate diluted 1:40 in a physiological buffer, or about 1 pg/mL to about 10 pg/mL of SMN in a whole blood lysate diluted 1:40 in a physiological buffer, or a sensitivity of about 5 pg/mL to about 10 pg/mL of SMN in a whole blood lysate diluted 1:40 in a physiological buffer. ELISA methods for detecting SMN in whole blood lysate fail to produce any appreciable reading to enable accurate quantification in whole blood lysate. (See FIG. 12). Under the best assay conditions, i.e. without matrix interference such as whole blood lysate components, ELISA generally provides a signal to noise ratio of about 60 when assaying SMN at approximately 20 ng/mL. In contrast, the ECL assay when performed using similar general assay conditions (i.e. not using whole blood lysate) at 20 ng/ml the signal to noise ratio is approximately 300.

What is claimed is:

1. A method for determining the level of survival motor neuron (SMN) protein in a whole blood sample from a subject, comprising: obtaining a whole blood sample from the subject; and conducting an electrochemiluminescence (ECL) immunoassay to determine the level of SMN in the whole blood sample.

2. The method of claim 1, wherein the whole blood sample is obtained using venipuncture procedure, a fingerstick procedure, or a heelstick procedure.

3. The method of claim 2, wherein conducting an electrochemiluminescence immunoassay to detect a level of SMN protein in the whole blood sample further comprises lysing at least a portion of the whole blood to form a whole blood lysate.

4. The method of claim 1, wherein the ECL immunoassay detects survival motor neuron 2 (SMN2) protein.

5. The method of claim 3, wherein conducting an electrochemiluminescence immunoassay to detect a level of SMN protein in the biological sample comprises:
a. combining the whole blood lysate with an anti-SMN capture antibody;
b. combining an ECL-labeled anti-SMN detection antibody with the combination of step a, thereby forming a complex;
c. applying an electrochemical potential to the complex;
d. measuring the amount of chemiluminescence released by the ECL label to determine the level of SMN present in the whole blood sample.

6. The method of claim 5, wherein the anti-SMN capture antibody is a 2B1 mouse monoclonal antibody and the anti-SMN detection antibody is a rabbit polyclonal antibody.

7. The method of claim 5, wherein the ECL-labeled anti-SMN detection antibody is tagged with an amine-reactive, N-hydroxysuccinimide ester linked to a caged ruthenium.

8. The method of claim 5, wherein an electrochemiluminescence reader is used to measure the amount of chemiluminescence released by the ECL label.

9. The method of claim 1, wherein the subject is a patient diagnosed with Spinal Muscular Atrophy.

10. A method for determining the level of survival motor neuron (SMN) protein in a cerebrospinal fluid (CSF) sample from a subject, comprising: obtaining the CSF sample from the subject; and conducting an electrochemiluminescence (ECL) immunoassay to determine the level of SMN in the CSF sample.

11. The method of claim 10, wherein the CSF sample is obtained using a lumbar puncture, a cisternal puncture, or a ventricular puncture.

12. The method of claim 10, wherein the ECL immunoassay detects survival motor neuron 2 (SMN2) protein.

13. The method of claim 3, wherein conducting an electrochemiluminescence immunoassay to detect a level of SMN protein in the CSF sample comprises:
a. combining the CSF sample with an anti-SMN capture antibody;
b. combining an ECL-labeled anti-SMN detection antibody with the combination of step a, thereby forming a complex;
c. applying an electrochemical potential to the complex;
d. measuring the amount of chemiluminescence released by the ECL label to determine the level of SMN present in the CSF sample.

14. The method of claim 13, wherein the anti-SMN capture antibody is a 2B1 mouse monoclonal antibody and the anti-SMN detection antibody is a rabbit polyclonal antibody.

15. The method of claim 13, wherein the ECL-labeled anti-SMN detection antibody is tagged with an amine-reactive, N-hydroxysuccinimide ester linked to a caged ruthenium.

16. The method of claim 13, wherein an electrochemiluminescence reader is used to measure the amount of chemiluminescence released by the ECL label.

17. The method of claim 1, wherein the subject is a patient diagnosed with Spinal Muscular Atrophy.


SEQUENCE LISTING (2 sequences)

SEQ ID NO: 1 - protein, 294 aa, Homo sapiens
MAMSSGGSGGGVPEQEDSVLFRRGTGQSDDSDIWDDTALIKAYDKAVASFKHALKNGDICETSGKPKTTPKRKPAKKNKSQKKNTAASLQQWKVGDKCSAIWSEDGCIYPATIASIDFKRETCVVVYTGYGNREEQNLSDLLSPICEVANNIEQNAQENENESQVSTDESENSRSPGNKSDNIKPKSAPWNSFLPPPPPMPGPRLGPGKPGLKFNGPPPPPPPPPPHLLSCWLPPFPSGPPIIPPPPPICPDSLDDADALGSMLISWYMSGYHTGYYMGFRQNQKEGRCSHSLN

SEQ ID NO: 2 - protein, 282 aa, Homo sapiens
MAMSSGGSGGGVPEQEDSVLFRRGTGQSDDSDIWDDTALIKAYDKAVASFKHALKNGDICETSGKPKTTPKRKPAKKNKSQKKNTAASLQQWKVGDKCSAIWSEDGCIYPATIASIDFKRETCVVVYTGYGNREEQNLSDLLSPICEVANNIEQNAQENENESQVSTDESENSRSPGNKSDNIKPKSAPWNSFLPPPPPMPGPRLGPGKPGLKFNGPPPPPPPPPPHLLSCWLPPFPSGPPIIPPPPPICPDSLDDADALGSMLISWYMSGYHTGYYMEMLA